(19) United States
(12) Patent Application Publication
(10) Pub. No.: US 2023/0419096 A1
(43) Pub. Date: Dec. 28, 2023

(54) SYSTEMS AND METHODS FOR CONCEALING UNINTERESTED ATTRIBUTES IN MULTI-ATTRIBUTE DATA USING GENERATIVE ADVERSARIAL NETWORKS

(71) Applicant: JPMORGAN CHASE BANK, N.A., New York, NY (US)

(72) Inventors: Richard CHEN, Baldwin Place, NY (US); Marco PISTOIA, Amawalk, NY (US); Shaohan HU, Yorktown Heights, NY (US); Bill MORIARTY, West Chester, PA (US); Hargun KALSI, Monmouth Junction, NJ (US)

(21) Appl. No.: 17/664,579

(22) Filed: May 23, 2022

(51) Int. Cl. G06N 3/08; G06F 21/62

(52) U.S. Cl. CPC G06N 3/08; G06F 21/6245

(57) ABSTRACT

Systems and methods for concealing uninterested attributes in multi-attribute data using generative adversarial networks are disclosed. In one embodiment, a method may include: an attribute concealing computer program receiving multi-attribute training data from a data source; pretraining a variational autoencoder to separate each attribute in the multi-attribute training data into a space; pretraining a decoder to reconstruct data from the spaces; receiving a plurality of additional data sets; receiving an identification of an uninterested attribute to conceal and an interested attribute to retain; training a multi-layer perceptron using the variational encoder, the decoder, the additional data sets, the uninterested attribute, and the interested attribute; receiving multi-attribute data for processing; and processing the multi-attribute data using the encoder, the multi-level perceptron, the decoder, and the additional data sets, wherein the processing results in the multi-attribute data with the uninterested attribute concealed and the interested attributes retained.

### BACKGROUND OF THE INVENTION

### 1. Field of the Invention

Embodiments are generally related to systems and methods for concealing uninterested attributes in multi-attribute data using generative adversarial networks.

### 2. Description of the Related Art

Multi-attribute data may include different types of data, and each type of data may be used for a different purpose. For example, an image or video of an individual's face may include data identifying the individual's identity, the individual's age, the individual's gender, the individual's sentiment, etc. Most individuals are concerned with concealing their identities; so, even if the other data elements are useful, the risk of leaking data regarding an individual's identity can prevent this other data from being used.

### SUMMARY OF THE INVENTION

Systems and methods for concealing uninterested attributes in multi-attribute data using generative adversarial networks are disclosed. In one embodiment, a method for concealing uninterested attributes using generative adversarial networks may include: (1) receiving, by an attribute concealing computer program, multi-attribute training data from a data source; (2) pretraining, by the attribute concealing computer program, a variational autoencoder to separate each attribute in the multi-attribute training data into a space; (3) pretraining, by the attribute concealing computer program, a decoder to reconstruct data from the spaces; (4) receiving, by the attribute concealing computer program, a plurality of additional data sets; (5) receiving, by the attribute concealing computer program, an identification of an uninterested attribute in the multi-attribute data to conceal and an interested attribute to retain; (6) training, by the attribute concealing computer program, a multi-layer perceptron using the variational encoder, the decoder, the additional data sets, the uninterested attribute, and the interested attribute; (7) receiving, by the attribute concealing computer program, multi-attribute data for processing; and (8) processing, by the attribute concealing computer program, the multi-attribute data using the encoder, the multi-level perceptron, the decoder, and the additional data sets, wherein the processing results in the multi-attribute data with the uninterested attribute concealed and the interested attribute retained.

In one embodiment, the variational autoencoder and the decoder may be pretrained using an autoencoding process.

In one embodiment, the variational autoencoder may be pretrained using a similarity loss between each attribute in the multi-attribute training data and the attribute in its space, and the reconstruction loss may be between the multi-attribute training data and the reconstructed data from the spaces. The similarity loss may include a cosine distance, and the reconstruction loss may include a L2 norm.

In one embodiment, the multi-attribute data may include streaming biometric data, image data, etc.

In one embodiment, the spaces may be latent spaces. The spaces may include volatile memory space, non-volatile memory space, etc.

According to another embodiment, a method for concealing uninterested attributes using generative adversarial networks may include: (1) receiving, by an attribute concealing computer program, multi-attribute training data from a data source; (2) pretraining, by the attribute concealing computer program, a variational autoencoder to separate each attribute in the multi-attribute training data into a space; (3) pretraining, by the attribute concealing computer program, a decoder to reconstruct data from the spaces; (4) receiving, by the attribute concealing computer program, a plurality of additional data sets; (5) receiving, by the attribute concealing computer program, an identification of an uninterested attribute in the multi-attribute data to conceal and an interested attribute to retain; (6) receiving, by the attribute concealing computer program, multi-attribute data for processing; and (7) processing, by the attribute concealing computer program, the multi-attribute data using the encoder, the decoder, and the additional data sets, wherein the processing results in the multi-attribute data with the uninterested attribute concealed and the interested attribute retained.

In one embodiment, the variational autoencoder and the decoder may be pretrained using an autoencoding process.

In one embodiment, the variational autoencoder may be pretrained using a similarity loss between each attribute in the multi-attribute training data and the attribute in its space, and the reconstruction loss may be between the multi-attribute training data and the reconstructed data from the spaces. The similarity loss may include a cosine distance, and the reconstruction loss may include a L2 norm.

In one embodiment, the multi-attribute data may include streaming biometric data, image data, etc.

In one embodiment, the spaces may be latent spaces. The spaces may include volatile memory space, non-volatile memory space, etc.

According to another embodiment, a method for concealing uninterested attributes using generative adversarial networks may include: (1) receiving, by an attribute concealing computer program, feature vector training data from a data source; (2) pretraining, by the attribute concealing computer program, an attribute concealer using the feature vector training data; (3) receiving, by the attribute concealing computer program, a plurality of additional data sets; (4) receiving, by the attribute concealing computer program, an identification of an uninterested attribute in the feature vector to conceal and an interested attribute to retain; (5) receiving, by the attribute concealing computer program, a feature vector for processing; and (6) processing, by the attribute concealing computer program, the feature vector using the attribute concealer and the additional data sets, wherein the processing results in the feature vector with the uninterested attribute concealed and the interested attribute retained.

In one embodiment, the attribute concealer may include a pretrained variational autoencoder and a pretrained decoder.

In one embodiment, the variational autoencoder and the decoder may be pretrained using an autoencoding process.

In one embodiment, the attribute concealer further may include a trained multi-layer perceptron.

In one embodiment, the attribute concealer may be trained to minimize a total loss between a training feature vector and a processed training feature vector, and a training feature vector attribute and a processed training feature vector:

In one embodiment, the feature vector may include non-perceptible data.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for concealing uninterested attributes in multi-attribute data using generative adversarial networks according to an embodiment;

FIG. 2 depicts a method for de-identifying multi-attribute data using a de-identification engine to conceal uninterested attributes using generative adversarial networks according to an embodiment;

FIG. 3 depicts a system for concealing uninterested attributes in multi-attribute data using generative adversarial networks according to another embodiment;

FIG. 4 depicts a method for de-identifying multi-attribute data using a de-identification engine to conceal uninterested attributes using generative adversarial networks according to another embodiment;

FIG. 5 depicts a system for concealing uninterested attributes in multi-attribute data using generative adversarial networks according to another embodiment;

FIG. 6 depicts a method for de-identifying multi-attribute data using a de-identification engine to conceal uninterested attributes using generative adversarial networks according to another embodiment.

### DETAILED DESCRIPTION OF PREFERRED EMBODIMENTS

Embodiments are directed to systems and methods for concealing uninterested attributes in multi-attribute data using generative adversarial networks (GANs). For example, data may include multiple attributes, such as interested attributes (e.g., any attributes selected to be retained) and uninterested attributes (e.g., any attributes selected to conceal). Existing approaches only conceal the uninterested attributes regardless of the consequence to any interested attributes. Thus, while the modified data does not include the uninterested attributes, any utility for the interested attributes by downstream tasks is destroyed.

By consider the interested and uninterested attributes together, embodiments ensure that the concealing of the uninterested attributes does not destroy the utility of the interested attributes to downstream tasks. For example, source data—such as an image of a person, a voice of a person, etc.—may have an uninterested attribute (e.g., age) that is hidden or concealed from the data such that when the interested attribute (e.g., gender) is retained and can be used by downstream tasks.

The disclosures of U.S. Provisional Patent Application Ser. Nos. 63/126,935 and 63/138,951 and of U.S. patent application Ser. No. 17/538,763 are hereby incorporated, by reference, in their entireties.

Although embodiments may be presented in the context of de-identification or anonymization of multi-attribute data (e.g., the uninterest attribute to be concealed is identity while the interested attributes, such as age, gender, etc. are maintained), it should be recognized that any attributes may be uninterested or interested. Thus, age may be an uninterested attribute, and identity may be an interested attribute, leading to a reconstruction in which the identity is perceptible, but an age is not. The number and type of interested and uninterested attributes may be set as is necessary and/or desired.

In embodiments, manipulated data may keep its utility for all/most downstream tasks, should not be identifiable, and the reconstructed data may be somehow realistic (e.g., if it is a visual dataset, it looks like a thing instead of random data).

In embodiments, a variational autoencoder (VAE) may be pre-trained to separate the spaces for each interested and uninterested attribute. A VAE is an autoencoder whose encodings distribution is regularized during the training in order to ensure that its space has good properties allowing the generation of new data. An example of a VAE is disclosed in Kingma et al., “Auto-Encoding Variational Bayes” (2013) available at arXiv:1312.6114, the disclosure of which is hereby incorporated, by reference, in its entirety.

Next, a de-identification process may be trained by training a multi-layer perceptron (MLP) on how to generate the data using, for example, an autoencoding process. In general, a MLP is a neural network comprising an input layer, a hidden layer, and an output layer. MLPs are bidirectional as they provide forward propagation of the inputs and backward propagation of the weights. Examples of autoencoding processes are disclosed in Goodfellow et al. “Deep Learning” MIT (2016), the disclosure of which is hereby incorporated, by reference, in its entirety. In embodiments, an autoencoding process may encode original data in a compact format and uses the compact format to regenerate the original data.

A decoder may be used to reconstruct data (e.g., an image, a sound, etc.) from the interested attributes in their manipulated space. During deployment, data may be provided, and other data may be selected (e.g., randomly) to manipulate the original data, resulting in data that has had the uninterested attribute concealed.

Alternatively, instead of training the de-identification process, data may be provided to the pre-trained encoder with additional data, and the uninterested attribute may be concealed.

In another embodiment, instead of using an encoder and a decoder, a feature vector may be used. For example, the data that is received may be non-perceptible data, that is data that is not capable of, or may not require, being reconstructed in a human-perceptible manner (such as an image, sound, etc.). Thus, a feature vector may represent a string of data, and an attribute may be concealed from the feature vector without regard to its reconstructability.

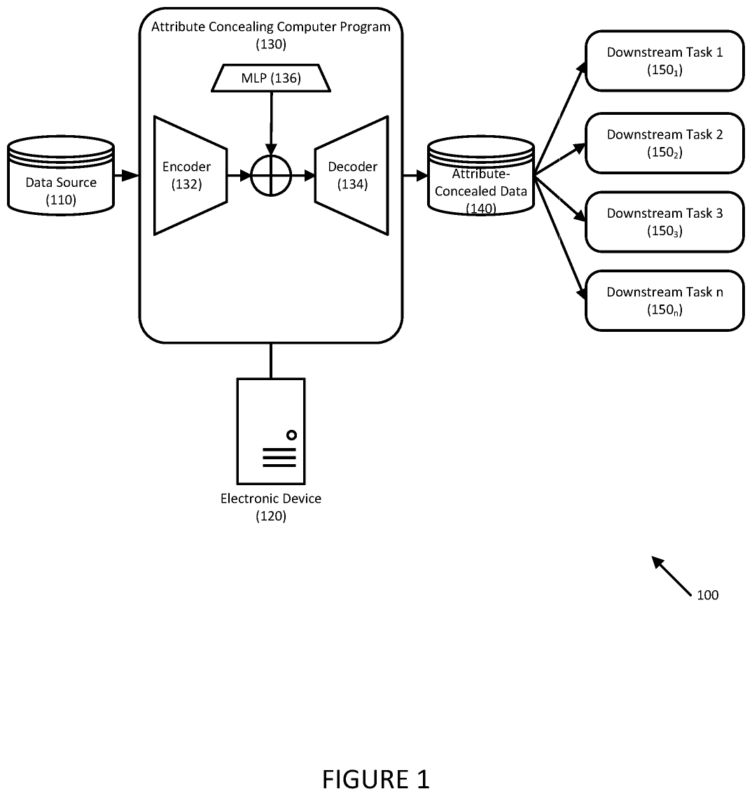

Referring to FIG. 1, a system for concealing uninterested attributes in multi-attribute data using generative adversarial networks is disclosed according to an embodiment. System 100 may include data source 110, which may be a source of image, voice, or any other data that is to have an attribute concealed.

Electronic device 120, such as a computer (e.g., server, workstation, desktop, notebook, laptop, tablet, etc.). may execute attribute concealing computer program 130, which may include encoder 132, decoder 134, and multi-layer perceptron 136. Encoder 132 may be a computer program that may separate each attribute in multi-attribute data into a space, such as a volatile memory space, a non-volatile memory space, etc. Decoder 134 may be a computer program that may combine the spaces into reconstructed data. During training, a similarity loss (e.g., a cosine difference) between each space and its associated attribute may be determined, and a reconstruction loss (e.g., L2 or Euclidean norm) between the original data and reconstructed data using a re-identification classifier may be determined. The losses may be fed back to train the encoder and decoder.

In one embodiment, the re-identification classifier may be pretrained based on standard cross-entropy loss when attribute labels are provided.

During de-identification, additional data sets may be retrieved from data source 110, and may be used to train a feedforward artificial neural network, such as multi-layer perceptron (MLP) 136. Data may be processed by trained decoder 134, and MLP 136 may pollute the space of the uninterested attribute, such that after decoding, the uninterested attributes cannot be discovered. The spaces may then be processed by trained decoder 134, resulting in reconstructed data. The reconstructed data may be compared to data from a trained re-identification classifier to maximize the loss with the re-identifier, and minimize the loss with the attributes. The losses may be KL divergent (logits), cosine similarity (feature), etc.

In one embodiment, the loss with the Re-ID may add another constraint, such as higher entropy.

The losses may be fed back to train MLP 136.

During deployment, data may be processed and provided to one or more downstream task 150 (e.g., downstream task 150₁, downstream task 150₂, downstream task 150₃, . . . downstream task 150ₙ).

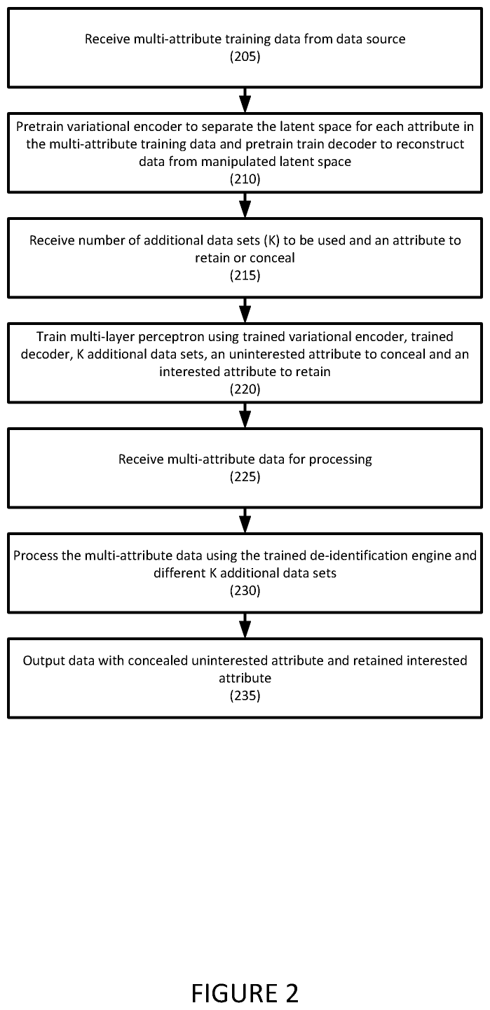

Referring to FIG. 2, a method for de-identifying multi-attribute data using a de-identification engine to conceal uninterested attributes using generative adversarial networks is disclosed according to an embodiment. In one embodiment, the method of FIG. 2 may be performed by system 100. In step 205, an attribute concealing computer program may receive multi-attribute training data from a data source. In one embodiment, the multi-attribute data may be training data that may be used to pretrain certain elements of an uninterested attribute concealing system, such as that in FIG. 1.

In step 210, the attribute concealing computer program may pretrain a variational autoencoder to present the data in a different space that differs from the original space. The space may be, for example, a volatile memory space, a non-volatile memory space, or any other suitable space that differs from the original space. The attribute concealing computer program may also pretrain a decoder to reconstruct data from manipulated attributes in the spaces. In one embodiment, an autoencoding technique may be used for the pretraining

In one embodiment, the variational autoencoder may be trained using a similarity loss between a space for an attribute and the attribute, and a reconstruction loss between the reconstructed data from the space and reconstructed data using a trained re-identification classifier. The similarity loss may be, for example, a cosine distance, and the reconstruction loss may be a L2 norm.

In step 215, the attribute concealing computer program may receive a number of additional data sets (K) to be used and an attribute to retain (e.g., an interested attribute) and an attribute to conceal (e.g., an uninterested attribute). In one embodiment, the attribute concealing computer program may receive a number K of additional data sets to use to conceal an attribute. For example, for biometric data, the attribute concealing computer program may receive an identification that identity is the attribute to conceal, and may receive 10 other biometric data sets to use to conceal the identity.

In step 220, the attribute concealing computer program may train a multi-layer perceptron using the trained variational encoder, the trained decoder, the K additional data sets, the identified uninterested attribute to conceal, and the interested attribute to retain.

In step 225, the attribute concealing computer program may receive multi-attribute data for processing. For example, the attribute concealing computer program may receive streaming biometric data including several attributes, including the attribute to conceal or retain. In one embodiment, the multi-attribute data may be received as streaming data, may be processed in batches, etc.

In step 230, the attribute concealing computer program may process the multi-attribute using the trained de-identification engine and different K additional data sets. The output may be a data set that has the identified attribute concealed.

In step 235, the attribute concealing computer program may output a data set with the uninterested attribute concealed, and the interested attributes retained. The data set may be used by one or more downstream system as is necessary and/or desired.

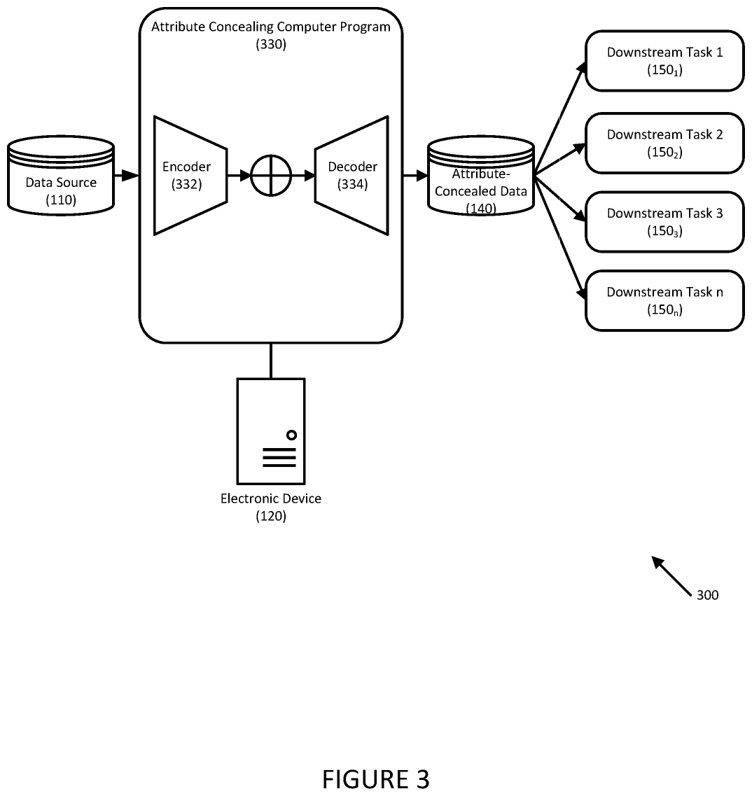

Referring to FIG. 3, a system for concealing uninterested attributes in multi-attribute data using generative adversarial networks according to another embodiment is disclosed. Like system 100, system 300 may include data source 110, electronic device 120, attribute-concealed data 140, and downstream tasks 150 (e.g., 150₁, 150₂, 150₃, . . . 150ₙ). System 300 may include attribute concealing computer program 330 that may be executed by electronic device 120. Attribute concealing computer program 330 may include encoder 332 and decoder 334, which may be similar to encoder 132 and decoder 134, respectively. Unlike system 100, however, system 300 does not use a trained multi-layer perceptron to produce attribute-concealed data 140.

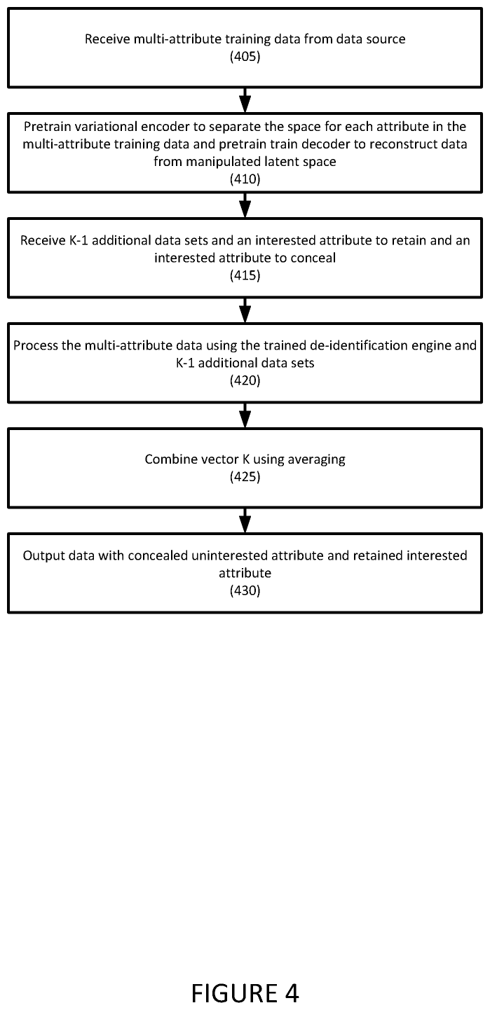

Referring to FIG. 4, a method for de-identifying multi-attribute data using a de-identification engine to conceal uninterested attributes using generative adversarial networks according to another embodiment is disclosed. In one embodiment, the method of FIG. 4 may be performed by system 300.

In step 405, an attribute concealing computer program may receive multi-attribute training data from a data source.

In step 410, the attribute concealing computer program may pretrain a variational autoencoder to separate the space for each attribute in the multi-attribute training data and may pretrain a decoder to reconstruct data from manipulated space. In one embodiment, an autoencoding technique may be used for the pretraining.

In step 415, the attribute concealing computer program may receive a number of additional data sets (K-1) to be used and an interested attribute to retain and an uninterested attribute to conceal. In one embodiment, the attribute concealing computer program may receive a number K-1 of additional data sets to use to conceal an attribute. For example, for biometric data, the attribute concealing computer program may receive an identification that identity is the attribute to conceal, and may receive 10 other biometric data sets to use to conceal the identity.

In one embodiment, the attribute concealing computer program may receive streaming biometric data including several attributes, including the uninterested attribute to conceal and the interested attribute to retain. In one embodiment, the multi-attribute data may be received as streaming data, may be processed in batches, etc.

In step 420, the attribute concealing computer program may process the multi-attribute using the trained de-identification engine and different K-1 additional data sets. The output may be a data set that has the identified attribute concealed.

In step 425, the attribute concealing computer program may combine the vector K using averaging. The output may be a data set that has the identified attribute concealed.

In step 430, the attribute concealing computer program may output a data set with the uninterested attribute concealed, and the interested attributes retained. The data set may be used by one or more downstream system as is necessary and/or desired.

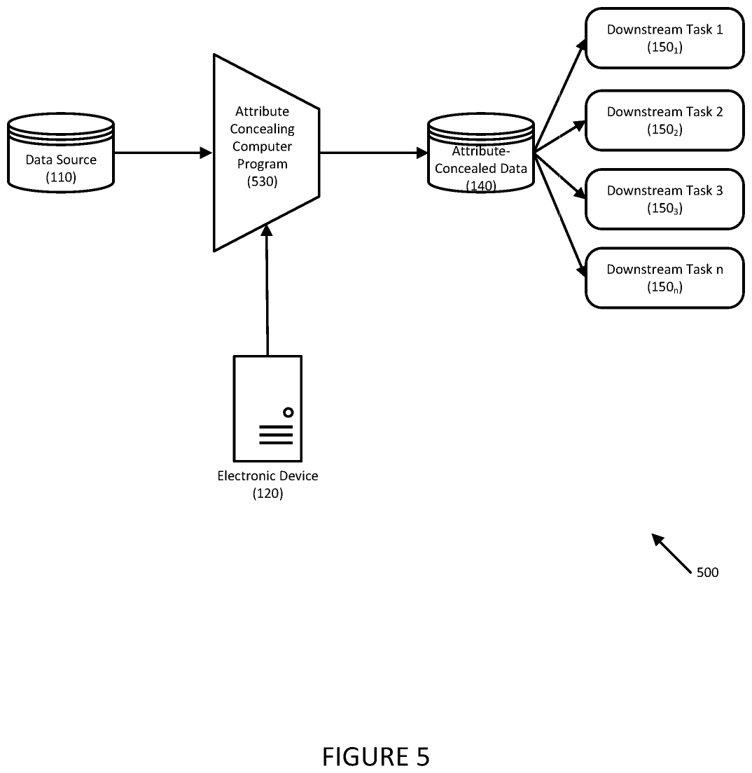

Referring to FIG. 5, a system for concealing uninterested attributes in multi-attribute data using generative adversarial networks according to another embodiment is disclosed. Like system 100, system 500 may include data source 110, electronic device 120, attribute-concealed data 140, and downstream tasks 150 (e.g., 150₁, 150₂, 150₃, . . . 150ₙ). System 500 may include attribute concealing computer program 530 that may be executed by electronic device 120. Attribute concealing computer program 530 may be similar to attribute concealing computer program 130 or attribute concealing computer program 330. In one embodiment, because data source 110 provides a feature vector, attribute concealing computer program 530 may not need an encoder or decoder.

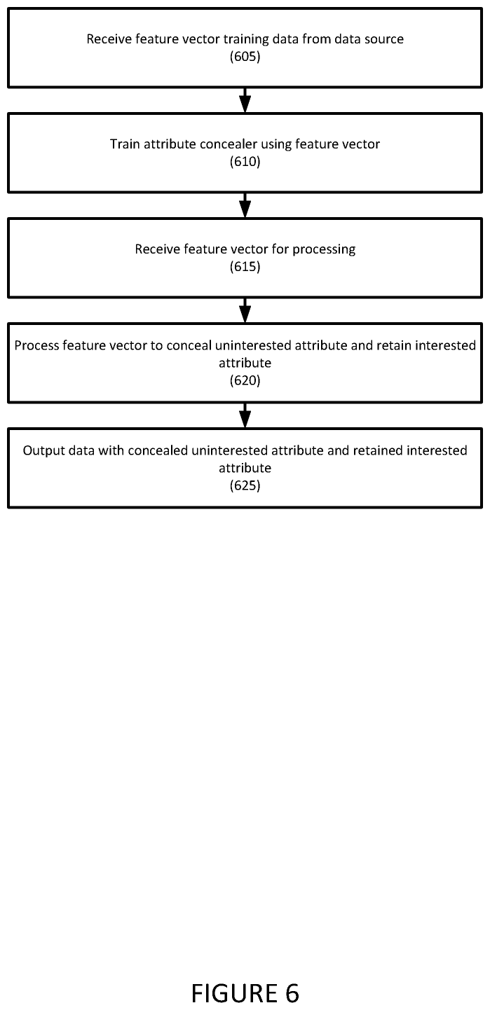

Referring to FIG. 6, a method for de-identifying multi-attribute data using a de-identification engine to conceal uninterested attributes using generative adversarial networks according to another embodiment is disclosed.

In step 605, an attribute concealing computer program may receive feature vector training data from data source.

In step 610, the attribute concealing computer program may train an attribute concealer using feature vector. In one embodiment, the attribute concealer may be similar to the attribute concealing computer program trained using the process of FIG. 2 (e.g., steps 205-220) or FIG. 4 (e.g., steps 405 and 410). In one embodiment, the attribute concealing computer program may be trained by comparing the uninterested attributes between the original feature vector and that in the concealed feature vector (i.e., the original feature vector after processing concealer computer program); at the same time, there is another loss is comparing the interested attributes in both the original and the concealed attributes since the interested attributes should still be inside the concealed data. The loss may be based on a comparison of the output to the original data, KL Diversity between the predicted logits from the original training data and the processed training data, cosine similarity between the attributes from the original training data and the output training data, etc.

For example, during training, the attribute concealing computer program may access the training data and train a machine learning engine with the training data. The training data may include the uninterested attribute, and the machine learning engine may be trained using a standard procedure, such as computing the gradients of weights by back-propagation.

During training, the user may provide the attribute concealing computer program with an identification of one or more attributes that are uninterested and one or more interested attributes to retain as this affects the equation of the training objectives. The attribute concealing program then minimizes the error for the interested attributes (e.g., non-uninterested attributes) while maximizing the error for uninterested attributes.

In one embodiment, the attribute concealer may be trained to minimize the total loss (L_{TOTAL}). For example, if the loss between the original training data and the processed data is L_{ID}, and the loss between the original attribute and the processed attribute is L_{ATTR}, the total loss may be minimized using the following equation:

L_{TOTAL}=w_{ID}*L_{ID}(R(x), R(x′), y_{ID})+w_{ATTR}*L_{ATTR}(A(x), A(x′), y_{ATTR})−H(R(x′))

wherein:
w are hyper parameters that are used to weight the different loss terms;
R is the pre-trained reidentification classifier;
x is the original feature vector;
x′ is the processed feature vector;
y is an attribute label for x;
A is a pretrained attribute classifier model trained on the attribute using supervised machine learning; and
H is an entropy classification.

In one embodiment, the entropy of predicted probability may be used to train the attribute concealing computer program by making the prediction more likely to be a random guess. A larger entropy will lead to a more random guess.

For original data (x) and pretrained attribute classifiers, an example training process fusing standard back propagation is as follows. The attribute concealing computer program generates concealed data (x′) from original data x, and both x and x′ are provided to attribute classifiers. Next, the total loss L_{TOTAL}, is calculated. Next, the gradient of the weights of attribute concealing computer program with respect to the L_{TOTAL} by back-propagation such that the weights in the attribute concealing computer program get the gradients. The weights of the attribute concealing computer program are then updated, and the process may be repeated for a desired number of iterations (e.g., 100 epochs, where each epoch denotes going through the whole dataset once).

Once trained, the attribute concealing computer program may be deployed.

In step 615, the attribute concealing computer program may receive a feature vector for processing. In one embodiment, the feature vector may be received as streaming data. In another embodiment, the feature vector may be the result of processing other data.

In step 620, the attribute concealing computer program may process the received feature vector to conceal the uninterested attribute that it is trained to conceal and retain the interested attributes that it is trained to retain. In one embodiments, users may not need to identify the uninterested or interested attributes as the attribute concealing computer program can only conceal the attributes that it is trained to conceal, and to retain those that it is trained to retain. For example, if the attribute concealing computer program is trained to conceal the uninterested attribute of identity while retaining the interested attribute of age, the attribute concealing computer program will conceal identity and retain age as it processes incoming data.

In step 625, the attribute concealing computer program may output a feature vector with the uninterested attribute concealed, and the interested attributes retained. The feature vector may be used by one or more downstream system as is necessary and/or desired.

Although multiple embodiments have been disclosed, it should be recognized that these embodiments are not exclusive to each other, and features from one embodiment may be used with other embodiments.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Further, it is not necessary that a single type of instruction or single programming language be utilized in conjunction with the operation of the system and method. Rather, any number of different programming languages may be utilized as is necessary and/or desired.

Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for concealing uninterested attributes using generative adversarial networks, comprising:
pretraining, by an attribute concealing computer program executed by an electronic device, a variational autoencoder to separate each attribute in multi- attribute training data received from a data source into a space;
pretraining, by the attribute concealing computer program, a decoder to reconstruct data from the spaces;
receiving, by the attribute concealing computer program, a plurality of additional data sets;
receiving, by the attribute concealing computer program, an identification of an uninterested attribute in the multi-attribute data to conceal and an interested attribute to retain;
training, by the attribute concealing computer program, a multi-layer perceptron using the variational encoder, the decoder, the additional data sets, the uninterested attribute, and the interested attribute; and
processing, by the attribute concealing computer program, multi-attribute data to process using the encoder, the multi-level perceptron, the decoder, and the additional data sets, wherein the processing results in the multi-attribute data with the uninterested attribute concealed and the interested attribute retained.

2. The method of claim 1, wherein the variational autoencoder and the decoder are pretrained using an autoencoding process.

3. The method of claim 1, wherein the variational autoencoder is pretrained using a similarity loss between each attribute in the multi-attribute training data and the attribute in its space, and a reconstruction loss between the multi-attribute training data and the reconstructed data from the spaces.

4. The method of claim 3, wherein the similarity loss comprises a cosine distance, and the reconstruction loss comprises a L2 norm.

5. The method of claim 1, wherein the multi-attribute data comprises streaming biometric data.

6. The method of claim 1, wherein the multi-attribute data comprises image data.

7. The method of claim 1, wherein the spaces comprise volatile memory space or non-volatile memory space.

8. A method for concealing uninterested attributes using generative adversarial networks, comprising:
pretraining, by an attribute concealing computer program executed by an electronic device, a variational autoencoder to separate each attribute in multi-attribute training data from a data source into a space;
pretraining, by the attribute concealing computer program, a decoder to reconstruct data from the spaces;
receiving, by the attribute concealing computer program, a plurality of additional data sets;
receiving, by the attribute concealing computer program, an identification of an uninterested attribute in the multi-attribute data to conceal and an interested attribute to retain;
receiving, by the attribute concealing computer program, multi-attribute data for processing; and
processing, by the attribute concealing computer program, the multi-attribute data using the encoder, the decoder, and the additional data sets, wherein the processing results in the multi-attribute data with the uninterested attribute concealed and the interested attribute retained.

9. The method of claim 8, wherein the variational autoencoder and the decoder are pretrained using an autoencoding process.

10. The method of claim 8, wherein the variational autoencoder is pretrained using a similarity loss between each attribute in the multi-attribute training data and the attribute in its space, and a reconstruction loss between the multi-attribute training data and the reconstructed data from the spaces.

11. The method of claim 10, wherein the similarity loss comprises a cosine distance, and the reconstruction loss comprises a L2 norm.

12. The method of claim 8, wherein the multi-attribute data comprises streaming biometric data.

13. The method of claim 8, wherein the multi-attribute data comprises image data.

14. The method of claim 8, wherein the spaces comprise volatile memory space or non-volatile memory space.

15. A method for concealing uninterested attributes using generative adversarial networks, comprising:
pretraining, by an attribute concealing computer program executed by an electronic device, an attribute concealer using feature vector training data received from a source;
receiving, by the attribute concealing computer program, a plurality of additional data sets;
receiving, by the attribute concealing computer program, an identification of an uninterested attribute in the feature vector to conceal and an interested attribute to retain;
receiving, by the attribute concealing computer program, a feature vector for processing; and
processing, by the attribute concealing computer program, the feature vector using the attribute concealer and the additional data sets, wherein the processing results in the feature vector with the uninterested attribute concealed and the interested attribute retained.

16. The method of claim 15, wherein the attribute concealer comprises a pretrained a variational autoencoder and a pretrained decoder.

17. The method of claim 16, wherein the variational autoencoder and the decoder are pretrained using an autoencoding process.

18. The method of claim 16, wherein the attribute concealer further comprises a trained multi-layer perceptron.

19. The method of claim 16, wherein the attribute concealer is trained to minimize a total loss between a training feature vector and a processed training feature vector, and a training feature vector attribute and a processed training feature vector.

20. The method of claim 15, wherein the feature vector comprises non-perceptible data.
